(19) United States
(12) Patent Application Publication
(10) Pub. No.: US 2010/0228794 A1
(43) Pub. Date: Sep. 9, 2010

(54) SEMANTIC DOCUMENT ANALYSIS

(75) Inventors: Sourashis Roy, New Delhi (IN); Himanshu Gupta, New Delhi (IN); Hiroki Oya, Kanagawa (JP); Mukesh Kumar Mohania, New Delhi (IN); Inagaki Iwao, Kanagawa (JP)

Correspondence Address: FREDERICK W. GIBB, III;Gibb Intellectual Property Law Firm, LLC, 844 West Street, SUITE 100, ANNAPOLIS, MD, 21401, US

(73) Assignee: International Business Machines Corporation, Armonk, NY (US)

(21) Appl. No.: 12/392,152

(22) Filed: Feb. 25, 2009

(51) Int. Cl. G06F 7/06; G06F 17/00; G06F 17/30

(52) U.S. Cl. 707/809; 715/231; 707/E17.044; 707/E17.058; 707/E17.062; 707/E17.069; 707/E17.083

(57) ABSTRACT

A technique for dynamic integration and semantic analysis of structured data and unstructured textual data including: defining and selecting static attributes and dynamic attribute from structured data, embedding static and dynamic views of the selected corresponding attributes in an annotated document, linking the unstructured textual data with the structured data using the defined static and dynamic attributes, populating an annotated document structure of multiple annotated documents, performing semantic analysis of a query across the unstructured textual data and structured data, querying the annotated document structure to provide query results satisfying static part of the query, processing static and dynamic parts of the query by querying structured data and the annotated document structure, as appropriate, and providing a combined query processing result satisfying the dynamic and static part the query. Other embodiments are also disclosed.

### BACKGROUND

As data and information grow in size and complexity, knowledge management needs also have grown. Typically, larger section of data and information resides in unstructured format than in structured format in enterprises, large and small. To address the needs of data and information integration across distributed, disparate and heterogeneous data and information sources, several techniques have evolved and have been studied. In addition, several techniques describe linking unstructured data with structured data. In conventional processes of linking unstructured data with structured data, various parts of data are classified into static and dynamic parts. The aspect of identifying static and dynamic parts of data is useful to optimize various performance metrics like query time.

Given a set of unstructured data sources and structured data sources, integrating them and linking them meaningfully to be able to query across these disparate, heterogeneous and distributed systems is very useful for a multitude of scientific and commercial activities. One of those includes transforming data into information and actionable intelligence and knowledge. Linking unstructured data to structured data manually is hard, expensive in terms of expertise and processing time and is prone to subjectivity. To link structured data and unstructured data automatically, entity or information extraction is often done using keywords (infrequent terms) appearing in unstructured data.

### SUMMARY

Embodiments of the invention are directed to a method, system and a computer program of dynamically integrating structured and unstructured textual data sources.

According to one embodiment of the invention, a method of integrating a structured data source and an unstructured textual data source is disclosed. The method accesses the structured data source and the unstructured textual data source, defines a static attribute and a dynamic attribute from the structured data source, selects the dynamic attribute from the structured data source, and embeds a dynamic view of the selected dynamic attribute in an annotated document. The method further selects the static attribute from the structured data source, embeds a static view of the selected static attribute in the annotated document.

According to a further embodiment of the invention is disclosed a method of using the annotated document obtained in the embodiment disclosed previously to create an annotated document structure and an index repository by linking the unstructured textual data source with the structured data source using the defined static attribute and the dynamic attribute, and populating the annotated document structure comprising the annotated document.

According to yet further embodiment of the invention is disclosed a method of querying the annotated document structure using the index repository by performing semantic analysis of a query across the unstructured textual data source and the structured data source, querying the annotated document structure to provide query results satisfying a static part of the query, processing a dynamic part of the query using querying at least one of the structured data source and the annotated document structure, and providing a combined query processing result satisfying the dynamic and the static part of the query.

Other embodiments of the invention are provided in the dependent claims.

### BRIEF DESCRIPTION OF THE DRAWINGS

Embodiments of the present invention are described in detail below, by way of example only, with reference to the following schematic drawings, where

FIG. 1 is a schematic drawing for the creation of an annotated document structure and an index repository according to an embodiment of the invention,

FIG. 2 shows a schematic drawing of an annotated document according to an embodiment of the invention,

FIG. 3 shows a schematic drawing of a query processor using index repository and structured data source,

FIG. 4 is a schematic illustration of a query processor according to an embodiment of the invention,

FIG. 5 is a schematic illustration of an analysis environment using the query processor as described in FIG. 3 and the annotated document structure and index repository as described in FIG. 1, and

FIG. 6 shows a schematic drawing of a data processing system for integrating structured data and unstructured textual data sources according to an embodiment of the invention.

### DETAILED DESCRIPTION

In the integration of unstructured data with structured data, there are two classes of data: static and dynamic. Static data is data fields that do not change very frequently, for example social security number of a person or birth date. Dynamic data on the other hand is likely to change more frequently. As an example of dynamic data one could consider an address of a person, mobile telephone number of a person etc.

To link these static and dynamic attributes of structured data with unstructured data, it is a common practice to deploy one of the following three approaches:

Materialized approach

Purely virtualized approach

Hybrid approach.

In materialized approach, annotations/metadata discovered from the structured data can be fully materialized into the unstructured document. The term “Materialized” means every row or record is computed, stored and maintained during updates of the source tables of the structured data source. In purely virtualized approach, ‘virtual views’ of annotations/metadata discovered from the structured database are created. Virtual view is a view where the records in the view result are neither computed nor stored. Materialized approach has the advantage of not requiring to query the database at run time. Materialized approach also has the drawback that not all changes in the database are reflected dynamically and hence may not provide accurate results. On the other hand, purely virtualized approach is able to reflect changes in the database automatically when the document is being accessed. The shortcoming of purely virtualized approach, however, is that it has increased response time.

Hybrid approach is partly materialized and partly virtual approach. Static data fields are materialized and dynamic attributes are virtualized. The query is federated and the results from static and dynamic parts are merged. Thus hybrid approach is able to utilize advantages of both: materialized approach and purely virtualized approach.

Several aspects of the embodiments of the invention present an end to end semantic analysis system that enables integration of structured data and unstructured textual data, wherein the semantic analysis system embeds static views and dynamic views in the annotated documents and indexes them so as to improve the accuracy and usefulness of a query to this system.

It should be noted that in the drawings, like elements, components, function blocks or apparatus are referred to by like reference numerals.

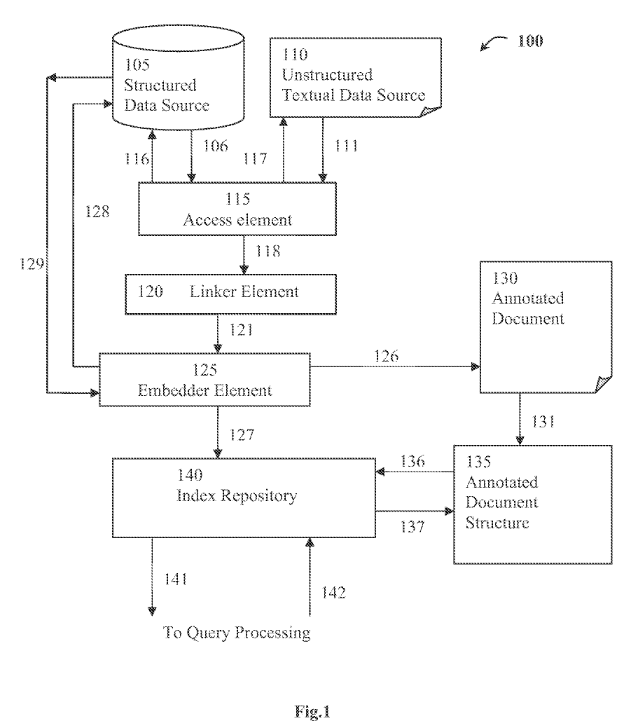

FIG. 1 is an exemplary embodiment of a schematic drawing for the creation of an annotated document structure and an index repository according to an embodiment of the invention and shows annotated document structure and index repository creation block 100 embodying a process for the creation of an annotated document structure and an index repository. Annotated document structure and index repository creation block 100 includes structured data source 105, unstructured textual data source 110, access element 115, linker element 120, embedder element 125, annotated document 130, annotated document structure 135, and index repository 140.

Access element 115 accesses data from structured data source 105 and is coupled over line 116 to structured data source 105. Structured data source 105 provides data over line 106 to access element 115. Access element 115 accesses data from unstructured textual data source 110 and is coupled over line 117 to unstructured textual data source 110. Unstructured textual data source 110 provides data over line 111 to access element 115.

Access element 115 also defines the ways to identify structured entities in unstructured data and classifies the structured attributes that need to be materialized and virtualized based on identification of static attributes and dynamic attributes. Access element 115 is coupled over line 118 to linker element 120.

Linker element 120 establishes links from the unstructured textual data to the structured data. Linker element 120 is coupled over line 121 to embedder element 125.

Embedder element 125 utilizes the links provided by the linker element 120. Embedder element 125 accesses structured data source 105 over line 128 and the required data is provided from structured data source 105 to embedder element 125 over line 129. Embedder element 125 creates annotated document 130 and is coupled over line 126 to annotated document 130.

Annotated document 130, which is stored in a memory, includes static views and dynamic views of the previously classified structured attributes. Embedder element 125 utilizes and collates a plurality of such annotated documents 130, one of which is shown in FIG. 1 as annotated document 130, and thus populates annotated document structure 135 which is stored in a memory. This collation of plurality of annotated documents 130 is provided over line 131 from one annotated document 130 to annotated document structure 135.

Embedder element 125, while populating and creating annotated document structure 135 also creates corresponding index repository 140. Embedder element 125 is coupled over line 127 to index repository 140 which is stored in a memory and has associated logic.

Index repository 140 functions to hold the various indexes that link unstructured data to the structured data. Exchange of information between index repository 140 and annotated documents structure 135 is facilitated over lines 136 and 137.

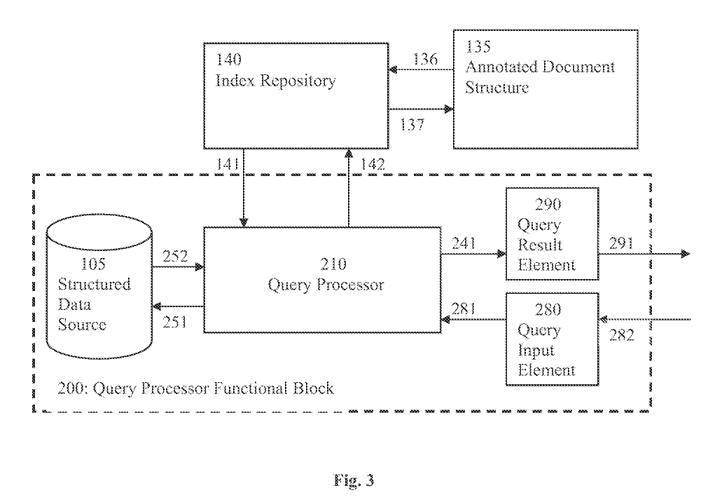

Index repository 140 facilitates communication and exchange of data over lines 141 and 142 for query processing, that is described in more detail in FIG. 3.

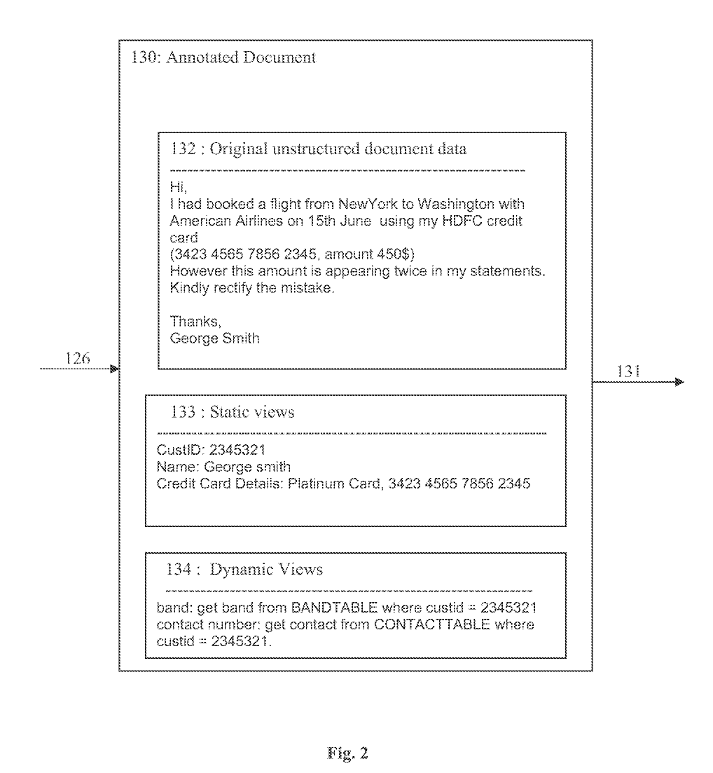

FIG. 2 illustrates an exemplary embodiment of an annotated document 130. Element 132 shows at least a part of textual representation of a communication. This could take the form of an e-mail, a part of the e-mail, any other textual communication or textual representation of multimedia communication etc. Element 133 shows static views associated with some or all of the static attributes identified in the textual communication. Element 134 holds dynamic views associated with some or all attributes identified as dynamic attributes in the textual communication. In this particular example, dynamic views of element 134 illustrate the use of SQL (Structured Query Language).

FIG. 3 illustrates an exemplary embodiment of query processor functional block 200, which processes an incoming query and communicates with annotated document structure 135 via index repository 140 also shown in FIG. 1. An incoming query to query processor functional block 200 is depicted by line 282. Communication between query processor functional block 200 and index repository 140 takes places over lines 141 and 142.

Query processor functional block 200 includes structured data source 105, query processor 210, query input element 280 and query result element 290. A query is received by query input element 280 over line 282. This query is sent by query input element 280 over line 281 to query processor 210. To obtain the results of the query, query processor 210 communicates with the structured data source 105 via line 251, and with index repository 140 via line 142. The results of the query are communicated by index repository 140 over line 141 to query processor 210. A part of the query result is communicated by structured data source 105 over line 252 to query processor 210. A combined query result is then passed on by query processor 210 to query result element 290 via line 241. Query result element then passes on the query result via line 291 to any consumer of this result.

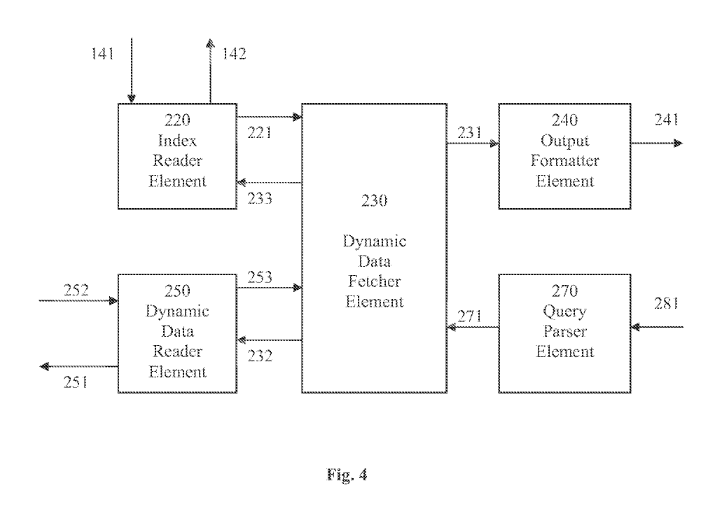

FIG. 4 further describes various elements of query processor 210. Query processor 210 includes index reader element 220, dynamic data fetcher element 230, output formatter element 240, dynamic data reader element 250, and query parser element 270.

When a query is received from query input element 280 as shown in FIG. 3, over line 281, query parser element 270 parses the query into its various parts. Parsed query is sent by query parser element 270 to dynamic data fetcher element 230 over line 271. Dynamic data fetcher element 230 analyzes the parsed query for static and/or dynamic part. Dynamic data fetcher element 230 communicates with dynamic data reader element 250 via line 232 for sending requests for fetching appropriate dynamic data. Dynamic data fetcher element 230 communicates with index reader element 220 via line 233 to send requests for fetching appropriate dynamic and static data. Corresponding results of static data and/or dynamic data are communicated by index reader element 220 to dynamic data fetcher element 230 via line 221. Corresponding results of dynamic data are communicated by dynamic data reader element 250 to dynamic data fetcher element 230 via line 253. Dynamic data fetcher element 230 then merges the dynamic and static parts of the results to evolve a combined query result and then communicates the combined query result to the output formatter element 240 via line 231. Output formatter element 240 formats the combined query result and communicates the combined query result over the line 241 to the query result element 290 as shown in FIG. 3.

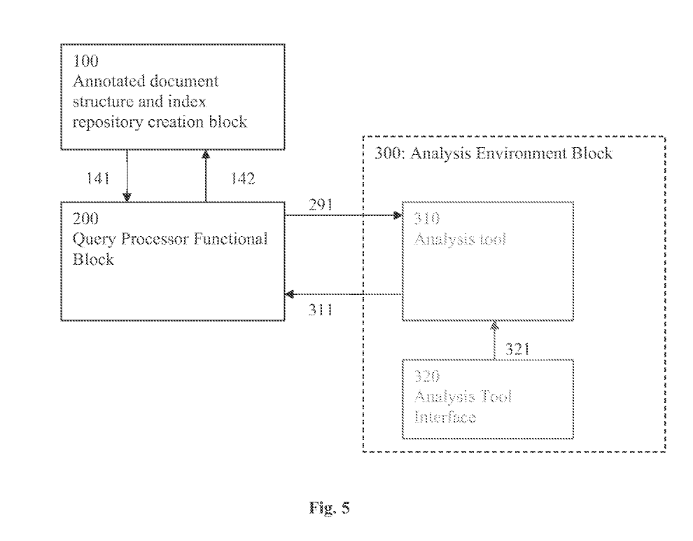

FIG. 5 describes the schematic of performing analysis. FIG. 5 includes annotated document structure and index repository creation block 100 as described in FIG. 1, query processor functional block 200 as described in FIG. 3 and analysis environment block 300. Analysis environment block 300 further includes analysis tool 310 and analysis tool interface 320.

FIG. 5 is an example of one of the uses of semantic query being an analysis tool which could be a business intelligence tool which may perform statistical, data mining or multidimensional analysis including OLAP (On-Line Analytical Processing) tooling.

Analysis tool 310 is coupled to analysis tool interface 320 over line 321. When an input signal is received by analysis tool 310 from analysis tool interface 320 over line 321, an appropriate request is sent by the analysis tool 310 to query processor functional block 200 via line 311. Some examples of analysis tool interface are pointer, keyboard, mouse or touch-screen. The combined query result obtained from query processor functional block 200 is sent to analysis tool 310 via line 291.

The disclosed embodiments may be combined with one or several of the other embodiments shown and/or described by a person skilled in the art. Combinations are also possible for one or more features of the embodiments.

A plurality of unstructured textual data sources 110, include but are not limited to e-mail, word processing documents, spreadsheets, presentation material, pdf files, web pages, news/media reports, case files, transcriptions, file servers, web servers, enterprise content, enterprise search tool repositories, intranet, knowledge management systems, and document management systems, metadata of audio signals rendered in text format, metadata of video signals rendered in text format, metadata of images rendered in text format, and metadata of multimedia rendered in text format.

The step of accessing structured data sources, performed in access element 115, includes but is not limited to SQL based access, and file system based access and the step of accessing unstructured textual data sources including but not limited to extracting, and parsing unstructured data.

The step of defining attributes, performed in access element 115, includes but is not limited to determining the topic of a section of unstructured textual data, extracting a section of unstructured textual data, matching entities, and matching terms.

The step of linking, performed in linker element 120, includes but is not limited to mapping a plurality of data elements between a structured data source and an unstructured textual data source.

The step of populating an annotated document structure, performed in embedder element 125, includes but is not limited to creation of an index repository that indexes plurality of annotated documents contained in an annotated document structure.

The step of performing semantic analysis, performed in query processor functional block 200, includes using query processor 210 capable of parsing the query into a static part and a dynamic part.

The step of querying annotated document structure 135, performed in query processor functional block 200, includes using query parser element 270 to parse the query and using a dynamic data fetcher element 230 to direct the static part of the query and /or the dynamic part of the query to index reader element 220.

The step of processing the query, performed in query processor functional block 200, includes using a query processor 210 for directing the dynamic part of the query to dynamic data reader element 250.

The step of providing the combined query processing result, performed in query processor functional block 200, includes using dynamic data fetcher element 230 and output formatter element 240 to merge obtained results for the static part of the query and the dynamic part of the query.

Analysis tool 310 includes a plurality of structured data tools such as business intelligence tools, statistical analysis tools, data visualization and mapping tools, and data mining tools.

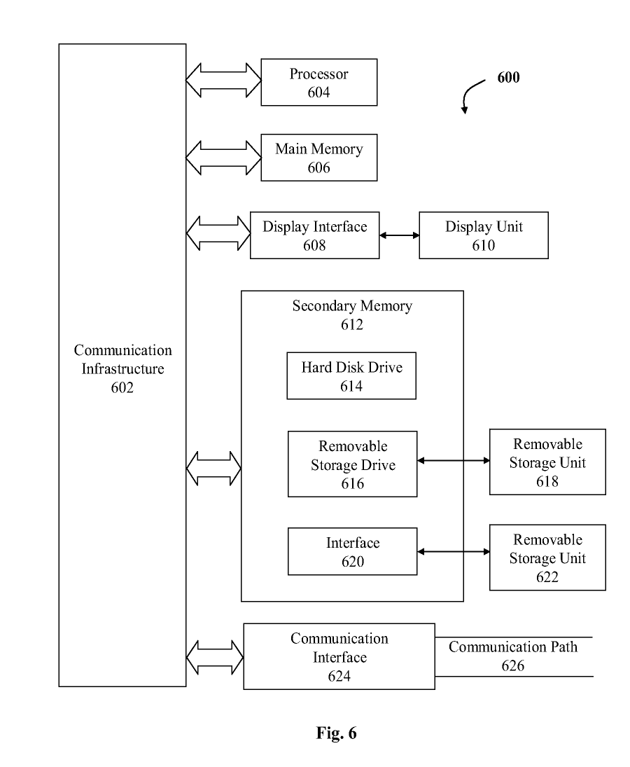

FIG. 6 is a block diagram of an exemplary computer system 600 that can be used for implementing exemplary embodiments of the present invention. Computer system 600 includes one or more processors, such as processor 604. Processor 604 is connected to a communication infrastructure 602 (for example, a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

Exemplary computer system 600 can include a display interface 608 that forwards graphics, text, and other data from the communication infrastructure 602 (or from a frame buffer not shown) for display on a display unit 610. Computer system 600 also includes a main memory 606, which can be random access memory (RAM), and may also include a secondary memory 612. Secondary memory 612 may include, for example, a hard disk drive 614 and/or a removable storage drive 616, representing a floppy disk drive, a magnetic tape drive, an optical disk drive, etc. Removable storage drive 616 reads from and/or writes to a removable storage unit 618 in a manner well known to those having ordinary skill in the art. Removable storage unit 618, represents, for example, a floppy disk, magnetic tape, optical disk, etc. which is read by and written to by removable storage drive 616. As will be appreciated, removable storage unit 618 includes a computer usable storage medium having stored therein computer software and/or data.

In exemplary embodiments, secondary memory 612 may include other similar means for allowing computer programs or other instructions to be loaded into the computer system. Such means may include, for example, a removable storage unit 622 and an interface 620. Examples of such may include a program cartridge and cartridge interface (such as that found in video game devices), a removable memory chip (such as an EPROM, or PROM) and associated socket, and other removable storage units 622 and interfaces 620 which allow software and data to be transferred from the removable storage unit 622 to computer system 600.

Computer system 600 may also include a communications interface 624. Communications interface 624 allows software and data to be transferred between the computer system and external devices. Examples of communications interface 624 may include a modem, a network interface (such as an Ethernet card), a communications port, a PCMCIA slot and card, etc. Software and data transferred via communications interface 624 are in the form of signals which may be, for example, electronic, electromagnetic, optical, or other signals capable of being received by communications interface 624. These signals are provided to communications interface 624 via a communications path (that is, channel) 626. Channel 626 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 606 and secondary memory 612, removable storage drive 616, a hard disk installed in hard disk drive 614, and signals. These computer program products are means for providing software to the computer system. The computer readable medium allows the computer system to read data, instructions, messages or message packets, and other computer readable information from the computer readable medium. The computer readable medium, for example, may include non-volatile memory, such as Floppy, ROM, Flash memory, Disk drive memory, CD-ROM, and other permanent storage. It can be used, for example, to transport information, such as data and computer instructions, between computer systems. Furthermore, the computer readable medium may comprise computer readable information in a transitory state medium such as a network link and/or a network interface, including a wired network or a wireless network, that allows a computer to read such computer readable information.

Computer programs (also called computer control logic) are stored in main memory 606 and/or secondary memory 612. Computer programs may also be received via communications interface 624. Such computer programs, when executed, can enable the computer system to perform the features of exemplary embodiments of the present invention as discussed herein. In particular, the computer programs, when executed, enable processor 604 to perform the features of computer system 600. Accordingly, such computer programs represent controllers of the computer system.

Although exemplary embodiments of the present invention have been described in detail, it should be understood that various changes, substitutions and alternations could be made thereto without departing from spirit and scope of the inventions as defined by the appended claims. Variations described for exemplary embodiments of the present invention can be realized in any combination desirable for each particular application. Thus particular limitations, and/or embodiment enhancements described herein, which may have particular advantages to a particular application, need not be used for all applications. Also, not all limitations need be implemented in methods, systems, and/or apparatuses including one or more concepts described with relation to exemplary embodiments of the present invention.

The described techniques may be implemented as a method, apparatus or article of manufacture involving software, firmware, micro-code, hardware such as logic, memory and/or any combination thereof. The term “article of manufacture” as used herein refers to code or logic and memory implemented in a medium, where such medium may include hardware logic and memory [e.g., an integrated circuit chip, Programmable Gate Array (PGA), Application Specific Integrated Circuit (ASIC), etc.] or a computer readable medium, such as magnetic storage medium (e.g., hard disk drives, floppy disks, tape, etc.), optical storage (CD-ROMs, optical disks, etc.), volatile and non-volatile memory devices [e.g., Electrically Erasable Programmable Read Only Memory (EEPROM), Read Only Memory (ROM), Programmable Read Only Memory (PROM), Random Access Memory (RAM), Dynamic Random Access Memory (DRAM), Static Random Access Memory (SRAM), flash, firmware, programmable logic, etc.]. Code in the computer readable medium is accessed and executed by a processor. The medium in which the code or logic is encoded may also include transmission signals propagating through space or a transmission media, such as an optical fiber, copper wire, etc. The transmission signal in which the code or logic is encoded may further include a wireless signal, satellite transmission, radio waves, infrared signals, Bluetooth, the internet etc. The transmission signal in which the code or logic is encoded is capable of being transmitted by a transmitting station and received by a receiving station, where the code or logic encoded in the transmission signal may be decoded and stored in hardware or a computer readable medium at the receiving and transmitting stations or devices. Additionally, the “article of manufacture” may include a combination of hardware and software components in which the code is embodied, processed, and executed. Of course, those skilled in the art will recognize that many modifications may be made without departing from the scope of embodiments, and that the article of manufacture may include any information bearing medium. For example, the article of manufacture includes a storage medium having stored therein instructions that when executed by a machine results in operations being performed.

Certain embodiments can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, certain embodiments can take the form of a computer program product accessible from a computer usable or computer readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

The terms “certain embodiments”, “an embodiment”, “embodiment”, “embodiments”, “the embodiment”, “the embodiments”, “one or more embodiments”, “some embodiments”, and “one embodiment” mean one or more (but not all) embodiments unless expressly specified otherwise. The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise.

Elements that are in communication with each other need not be in continuous communication with each other, unless expressly specified otherwise. In addition, elements that are in communication with each other may communicate directly or indirectly through one or more intermediaries. Additionally, a description of an embodiment with several components in communication with each other does not imply that all such components are required. On the contrary a variety of optional components are described to illustrate the wide variety of possible embodiments.

Further, although process steps, method steps or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously, in parallel, or concurrently. Further, some or all steps may be performed in run-time mode.

When a single element or article is described herein, it will be apparent that more than one element/article (whether or not they cooperate) may be used in place of a single element/article. Similarly, where more than one element or article is described herein (whether or not they cooperate), it will be apparent that a single element/article may be used in place of the more than one element or article. The functionality and/or the features of an element may be alternatively embodied by one or more other elements which are not explicitly described as having such functionality/features. Thus, other embodiments need not include the element itself.

Computer program means or computer program in the present context mean any expression, in any language, code or notation, of a set of instructions intended to cause a system having an information processing capability to perform a particular function either directly or after either or both of the following a) conversion to another language, code or notation; b) reproduction in a different material form.

Embodiments of the invention further provides a storage medium tangibly embodying a program of machine-readable instructions to carry out a method of integrating a structured data source and an unstructured textual data source, the machine readable instructions executable by a digital processing apparatus capable of performing:

accessing the structured data source and the unstructured textual data source;

defining a static attribute and a dynamic attribute from the structured data source;

selecting the dynamic attribute from the structured data source;

embedding a dynamic view of the selected dynamic attribute in an annotated document;

selecting the static attribute from the structured data source;

embedding a static view of the selected static attribute in the annotated document;

linking the unstructured textual data source with the structured data source using the defined static attribute and the defined dynamic attribute;

populating an annotated document structure comprising the annotated document;

performing semantic analysis of a query across the unstructured textual data source and the structured data source;

querying the annotated document structure to provide query results satisfying static part of the query;

processing a dynamic part of the query using querying of the structured data source and the annotated document structure; and

providing a combined query processing result satisfying the dynamic part and the static part of the query.

What is claimed is:

1. A method for integrating a structured data source and an unstructured textual data source, the method comprising:
selecting a dynamic attribute from the structured data source; and
embedding a dynamic view of the selected dynamic attribute in an annotated document.

2. The method of claim 1, further comprising:
selecting a static attribute from the structured data source; and
embedding a static view of the selected static attribute in the annotated document.

3. The method of claim 2, further comprising:
accessing the structured data source and the unstructured textual data source; and
defining the static attribute and the dynamic attribute from the structured data source.

4. The method of claim 3, further comprising:
linking the unstructured textual data source with the structured data source using the defined static attribute and the dynamic attribute; and
populating an annotated document structure comprising the annotated document.

5. The method of claim 4, further comprising:
performing semantic analysis of a query across the unstructured textual data source and the structured data source.
querying the annotated document structure to provide query results satisfying a static part of the query.

6. The method of claim 5, further comprises:
processing a dynamic part of the query using querying of the structured data source and the annotated document structure.

7. The method of claim 6, further comprises:
providing a combined query processing result satisfying the dynamic part and the static part of the query.

8. The method of claim 1, wherein the step of embedding the dynamic view includes creating the annotated document including the dynamic view and one selected from a set comprising a static view of a static attribute and content of the unstructured textual data.

9. The method of claim 1, wherein the unstructured textual data source includes one selected from a set comprising:
email, word processing documents, spreadsheets, presentation material, pdf file, web page, news/media report, case file, transcription, file server, web server, enterprise content, enterprise search tool repositories, intranet, knowledge management system, and document management system, metadata of audio signal rendered in text format, metadata of video signal rendered in text format, metadata of image rendered in text format, and metadata of multimedia rendered in text format.

10. The method of claim 3, wherein the step of accessing structured data source includes one selected from a set comprising SQL based access, and file system based access and the step of accessing unstructured textual data source includes one selected from a set comprising extracting, and parsing the unstructured data.

11. The method of claim 3, wherein the step of defining includes one selected from the set comprising determining the topic of a section of the unstructured textual data, extracting a section of the unstructured textual data, matching entities, and matching terms.

12. The method of claim 4, wherein the step of linking includes mapping plurality of data elements between the structured data source and the unstructured textual data source.

13. The method of claim 4, wherein the step of populating the annotated document structure includes creation of an index repository that indexes plurality of annotated documents contained in annotated document structure.

14. The method of claim 5, wherein the step of performing semantic analysis includes using a query processor capable of parsing the query in static part and dynamic part.

15. The method of claim 5, wherein the step of querying the annotated document structure includes using a query parser to parse the query and using a dynamic data fetcher to direct static part of the query to an index reader.

16. The method of claim 6, wherein the step of processing the query includes using a query processor for directing dynamic part of the query to a dynamic data reader.

17. The method of claim 7, wherein step of providing the combined query processing result includes using a dynamic data fetcher and an output formatter to merge obtained results for the static part of the query and the dynamic part of the query.

18. A method of integrating a structured data source and an unstructured textual data source comprising:
accessing the structured data source and the unstructured textual data source;
defining a static attribute and a dynamic attribute from the structured data source;
selecting the dynamic attribute from the structured data source;
embedding a dynamic view of the selected dynamic attribute in an annotated document;
selecting the static attribute from the structured data source;
embedding a static view of the selected static attribute in the annotated document;
linking the unstructured textual data source with the structured data source using the defined static attribute and the defined dynamic attribute;
populating an annotated document structure comprising the annotated document;
performing semantic analysis of a query across the unstructured textual data source and the structured data source;
querying the annotated document structure to provide query results satisfying a static part of the query;
processing a dynamic part of the query using querying of the structured data source and the annotated document structure; and
providing a combined query processing result satisfying the dynamic part and the static part of the query.

19. The method of claim 18, further includes:
analyzing the combined query processing result satisfying the dynamic part and the static part of the query.

20. The method of claim 18, wherein at least one of the steps is performed in run-time mode.

21. The method of claim 19, wherein step of analyzing the combined query processing result includes use of a structured data tool.

22. The method of claim 21, wherein the structured data tool includes one selected from a set comprising: business intelligence tool, statistical analysis tool, data visualization and mapping tool, and data mining tool.

23. A system for integrating a structured data source and an unstructured textual data source comprising:
processing unit for accessing the structured data source and the unstructured textual data source;
processing unit for defining a static attribute and a dynamic attribute from the structured data source;
processing unit for selecting the dynamic attribute from the structured data source;
processing unit for embedding a dynamic view of the selected dynamic attribute in an annotated document;
processing unit for selecting the static attribute from the structured data source;
processing unit for embedding a static view of the selected static attribute in the annotated document;
processing unit for linking the unstructured textual data source with the structured data source using the defined static attribute and the defined dynamic attribute;
processing unit for populating an annotated document structure comprising the annotated document;
processing unit for performing semantic analysis of a query across the unstructured textual data source and the structured data source;
processing unit for querying the annotated document structure to provide query results satisfying a static part of the query;
processing unit for processing a dynamic part of the query using querying of the structured data source and the annotated document structure; and
processing unit for providing a combined query processing result satisfying the dynamic part and the static part of the query.

24. The system of claim 23, further including
processing unit for analyzing the combined query processing result satisfying the dynamic part and the static part of the query.

25. A storage medium tangibly embodying a program of machine-readable instructions to carry out a method of integrating a structured data source and an unstructured textual data source, the machine readable instructions executable by a digital processing apparatus capable of performing:
accessing the structured data source and the unstructured textual data source;
defining a static attribute and a dynamic attribute from the structured data source;
selecting the dynamic attribute from the structured data source;
embedding a dynamic view of the selected dynamic attribute in an annotated document;
selecting the static attribute from the structured data source;
embedding a static view of the selected static attribute in the annotated document;
linking the unstructured textual data source with the structured data source using the defined static attribute and the defined dynamic attribute;
populating an annotated document structure comprising the annotated document;
performing semantic analysis of a query across the unstructured textual data source and the structured data source;
querying the annotated document structure to provide query results satisfying a static part of the query;
processing a dynamic part of the query using querying of the structured data source and the annotated document structure; and
providing a combined query processing result satisfying the dynamic part and the static part of the query.
